(19) United States
(12) Patent Application Publication
(10) Pub. No.: US 2006/0045643 A1
(43) Pub. Date: Mar. 2, 2006

(54) Level-adjustable tool support

(75) Inventor: Kurt Petersen, Austin, TX (US)

Correspondence Address: COX SMITH MATTHEWS INCORPORATED, 112 EAST PECAN STREET, SUITE 1800, SAN ANTONIO, TX, 78205-1521, US

(73) Assignee: Phillip A. Adams

(21) Appl. No.: 10/925,791

(22) Filed: Aug. 25, 2004

(51) Int. Cl. B23C 1/20

(52) U.S. Cl. 409/182; 409/214; 144/136.95

(57) ABSTRACT

A tool support adjusts the level of, for example, a tool mounted behind the work surface of a plate so as to vary how far the tool working implement extends through and beyond the work surface. The tool support includes a plurality of threaded rods fixed at one end to the plate, a carriage mounted to the threaded rods and holding the tool, a drive rod and a gear train. Rotation of the drive rod effects, through the gear train, translation of the carriage along the threaded rods, thus advancing or withdrawing the tool working implement through an aperture in the plate. A distance gauge informs an operator how far beyond the work surface the working implement protrudes or how far the carriage has traveled. Other embodiments include a drive motor, various gear train configurations involving posts and gear racks, and translating the carriage within a cylinder.

### BACKGROUND

Generally, a tool may be situated below the top of or behind a work surface, such as that of a table, in a manner that the working implement of the tool protrudes through the work surface. A work piece, such as a piece of wood, may be placed on the work surface and shaped by the working implement protruding therethrough. Such table-mounted tools include saws, routers, sanders, and the like having working implements of a saw blade, router bit, or sanding spindle, respectively.

In the case of a horizontal table-mounted router used for woodworking, for example, the working implement of the router, i:e., a router bit, protrudes through the work surface. When power is supplied to the router, the router bit spins at high speed, and may be used to cut a piece of wood placed against the bit. Generally, the shape of the cut is defined by the design of the router bit. The depth of the cut, however, is typically adjusted by raising or lowering the router below the table so as to vary the distance that the router bit extends beyond the work surface.

### BRIEF DESCRIPTION OF THE DRAWINGS

FIG. 1 is a perspective view depicting an embodiment of a removable assembled tool support holding a router.

FIG. 2 is a perspective view of the tool support of FIG. 1 from a different perspective and without the router.

FIG. 3 is a perspective view of the carriage and gear train in partially exploded form.

FIG. 4 is a side view of an output gear on the threaded rod of FIG. 1.

FIG. 5 is a perspective sectional view of the assembled carriage and gear train of FIG. 1.

FIG. 6 is a perspective view depicting the orientation of a router for mounting in the tool support of FIG. 1.

FIG. 7 is a top view of the working surface of the plate of FIG. 1.

FIG. 8 is an “exploded” view depicting the spring drag interface of the mechanical distance gauge of FIG. 7.

FIG. 9 is a perspective view depicting an embodiment of a motor driven removable tool support holding a router.

FIG. 10 is a perspective view depicting another embodiment of a motor driven removable tool support holding a router.

FIG. 11 is a partially-“exploded” view depicting yet another embodiment of a motor driven removable tool support holding a router.

FIG. 12 is a perspective view depicting an embodiment of a removable tool support utilizing worm gears.

FIG. 13 is a perspective view depicting an embodiment of a removable tool support utilizing a threaded cylindrical tube.

FIG. 14 is a partially-“exploded” view depicting the gear train of FIG. 13.

FIG. 15 is a perspective view depicting an embodiment of a removable tool support utilizing a smooth tube and threaded drive rod.

### DETAILED DESCRIPTION

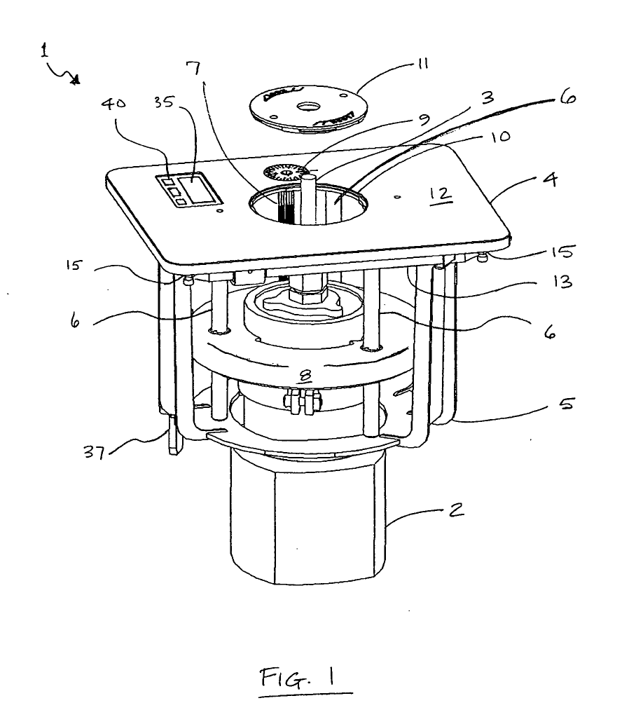

FIG. 1 illustrates one embodiment of the tool support 1. In this embodiment, the tool support 1 is configured to support a router 2 having a router bit 3, and is further configured for removable mounting in a horizontal table. The tool support 1 of this embodiment generally includes a plate 4, a frame 5, three threaded rods 6, a drive rod 7, a carriage 8, and a distance gauge 9. The tool support 1 holds the router 2 such that the router bit 3 may protrude through a hole or aperture 10 through the plate 4. In this embodiment, the router bit 3 protrudes perpendicularly through the hole 10. Also, the hole 10 may further be fitted with a reduction ring 11 to effectively reduce the diameter of the hole 10.

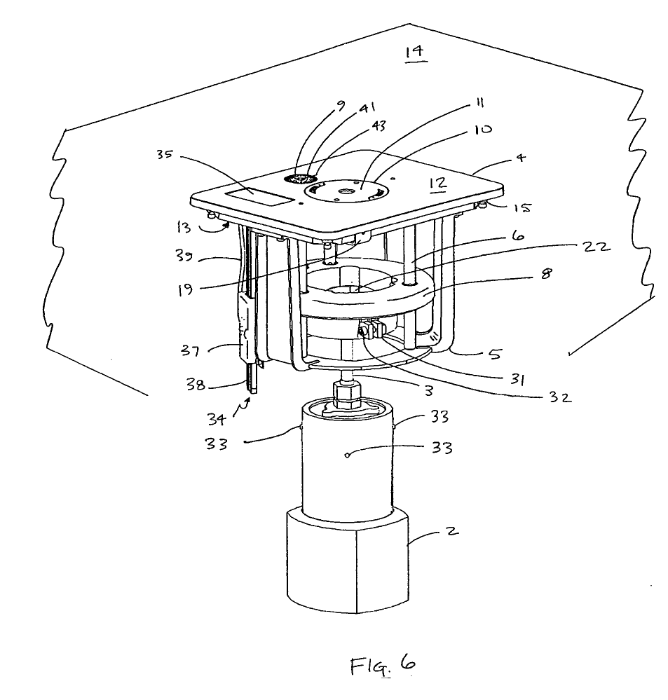

In the embodiment of FIG. 1, one side of the plate 4 is a substantially flat and smooth work surface 12 against which a work piece (not shown), such as wood, may be placed. The opposite side of the plate 4 is a utility surface 13 preferably configured, such as with bosses, ribs or mounting holes, to permit mounting of the frame 5 and other parts of the tool support 1. In this embodiment, the plate 4 is generally configured to fit flush into a larger work surface, such as the table 14 depicted in FIG. 6. Preferably, the plate 4 is made of metal, or other hard material.

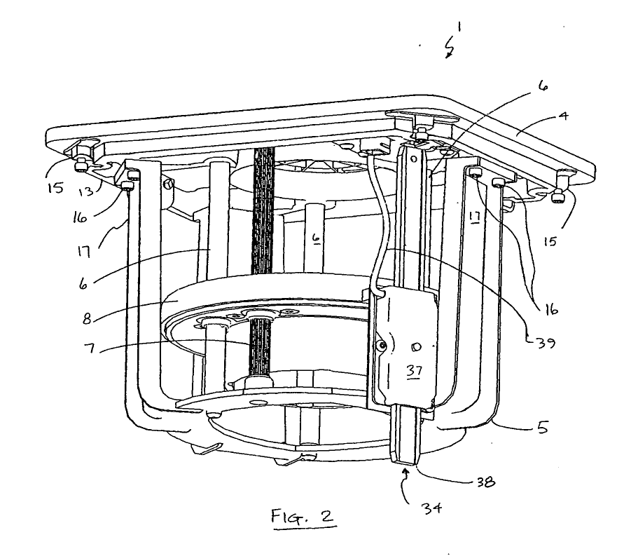

As seen in FIGS. 1 and 2, the frame 5 is a rigid structure mounted to the plate 4. The frame 5 is fixedly mounted to the plate 4 by, for example, bolts 16. Of course, the frame 5 could be fixed to the plate 4 by other means, such as by a weld, an adhesive, friction fit, or a snap-in configuration. In the embodiment of FIG. 2, the frame 5 is provided with three mounting arms 17 for three-point mounting to the utility surface 13 of plate 4. Preferably, the frame 5 is made of a non-deformable material, such as metal.

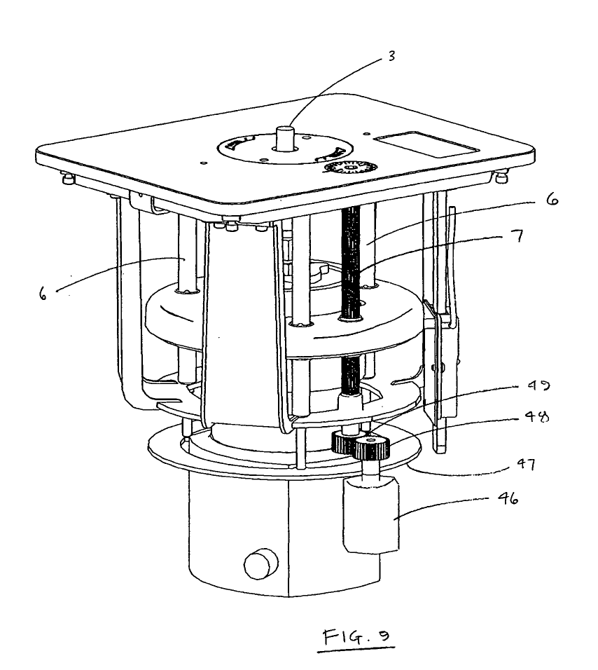

The tool support 1 further includes three threaded rods 6. Each threaded rod 6 is non-rotatably fixed at one end to the utility surface 13 of the plate 4 and at the other end to the frame 5. In this embodiment, the threaded rods 6 are oriented parallel to each other, are perpendicular to the work surface 12 of the plate 4 and are evenly spaced around the hole 10 in the plate 4. Those skilled in the art will appreciate that the tool support 1 may include more or less than three threaded rods 6, that the threaded rods 6 do not have to be perpendicular to the work surface 12, and do not have to be evenly spaced around the hole 10. Also, the threaded rods 6 do not necessarily have to terminate at the frame 5; rather, they may extend beyond the frame 5. That is, the frame 5 may be fixed to a threaded rod 6 at a place other than at the end. Such a configuration may, for example, allow the threaded rods 6 to be used as mounting points for other devices and equipment. For example, a vacuum or vacuum hose (not shown) could be mounted, in a manner similar to that of the drive motor 46 depicted in FIG. 9, to the part of a threaded rod 6 extending beyond the frame 5 in order to vacuum particles and debris through the hole 10 in the plate 4. Such a configuration may allow the bulk of the vacuum hose to be supported by the threaded rods 6, while the suction end of the hose is situated near the hole 10 in the plate 4. Furthermore, to explain one way in which the threaded rods 6 do not have to be perpendicular to the working surface 12, those of skill in the art will appreciate that the plate may be of a multi-piece design configured to allow the threaded rods 6, while remaining parallel, to be tilted at a desired angle relative to the working surface 12. Of course, the threaded rods 6 may also be fixed directly to the plate 4 in a non-perpendicular manner, as well.

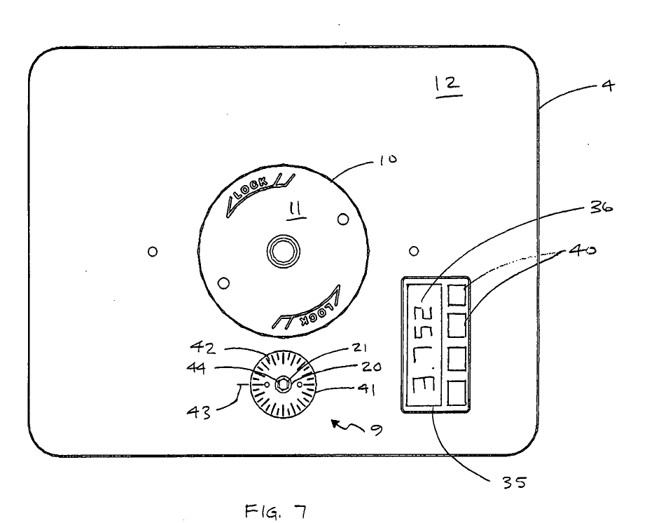

Referring again to FIG. 2, the tool support 1 also includes a drive rod 7 rotatably mounted at one end 20 to the plate 4 and rotatably mounted at the other end to the frame 5. As with the threaded rods 6, of course, the drive rod 7 need not terminate at the frame 5, but may extend through the frame 5. As better seen in FIG. 7, an operator may access one end 20 of the drive rod 7 through the work surface 12 of the plate 4 to turn the drive rod 7. In that embodiment, the end 20 of the drive rod 7 is configured with, for example, an internal hex drive 21 so that the drive rod 7 may be turned by a hex wrench (not shown) inserted therein. Alternatively, the drive rod 7 may be fitted with, for example, a bevel gear train (not shown) or worm gear train (not shown) that allows the drive rod 7 to be turned indirectly by a wrench or other tool. In other embodiments, the drive rod 7 may be belt- or chain-driven, and may be turned manually or by a motor or other servomechanism.

Use of a drive motor provides a way for rapid advancement of the carriage 8, as well as precise and electronically measurable movement. For example, in the embodiment shown in FIG. 9 in which the threaded rods 6 and drive rod 7 extend beyond the frame 5, a drive motor frame 47 having a drive motor 46 may be mounted to the part of the threaded rods 6 extending beyond the frame 5, and engaged with the drive rod 7 through a gear train. In the embodiment of FIG. 9, a drive gear 48 is mounted to the output shaft of the drive motor 46, and engages an input gear 49 on the drive rod 7. Of course, the output shaft of the motor 46 could itself be provided with teeth to engage the drive rod 7 directly, thus avoiding the need for the gears 48 and 49. By way of further example, the motor, having a bevel gear, such as a miter bevel gear, mounted to the motor output shaft, could be oriented perpendicularly to the drive rod 7, to engage a mating bevel gear mounted to a part of the drive rod 7 extending beyond the frame 5. That is, gears 48 and 49 could, for example, be mating bevel gears and the output shaft of the motor 46 could just as well be oriented perpendicularly to the drive rod 7. Those skilled in the art will also appreciate that other gear arrangements, such as those utilizing worm gear, hypoid gear, spur gear, helical gear, belt, chain, or the like, may be used to transfer rotary motion of the motor output shaft to the drive rod 7. Of course, the motor itself may be a servo-type motor or otherwise, and may be remotely actuated by the operator through, for example, the switches 40, or a controller in wireless communication with motor control circuitry, such as servo circuitry. Also, such circuitry may, in another embodiment, e.g., the embodiment of FIG. 7, provide an output 36 to the display screen 35 (that may be shared by the electronic distance gauge 34), such as how far (based, for example, on the thread pitch of the threaded rods 6, and gear configuration) the carriage 8 has moved along the threaded rods 6. For example, those skilled in the art will appreciate that a digitally- or sinusoidally-actuated servo motor can be programmed to provide precise control over the distance traveled by the carriage 8, and can output a variety of distance and angular-rotation information to a user. Additionally, other embodiments of the tool support 1 include mounting a motor in other locations, such as to the utility surface 13 of the plate 4, which may require using a different gear or drive arrangement, such as those described above, for transferring rotary motion from the motor output shaft to the drive rod 7. Alternatively, such a motor position may require use of a flexible drive shaft, or one or more universal joints, to drivably connect the motor output shaft to the drive rod 7. Such variations in motor placement and gear and drive shaft arrangement will, of course, be apparent to those of skill in the art. As noted above, those skilled in the art will recognize that motors can also be used to advance the carriage 8 along the threaded rods 6 much more rapidly than can be achieved by hand. Nevertheless, those skilled in the art will also appreciate that the gear train may also include a simple two-speed (or more) transmission to allow rapid (gross) manual advancement of the carriage 8 along the threaded rods 6 if one train of gears is selected, and precise (fine) advancement of the carriage 8 if a different train of gears is selected. For example, such a transmission may be particularly helpful if the drive motor only runs at a single speed, or if the drive rod 7 is rotated by hand. Also, such a transmission may include belts, chains, pulleys, and the like, in place of or in addition to gears.

The embodiment of the tool support primarily described up to this point has included a frame 5. Those skilled in the art will appreciate that the tool support 1 does not require a frame 5. That is, in another embodiment, the threaded rods 6 may simply be mounted at one end to the plate 4, and free at the other end. Likewise, the drive rod 7 may be rotatably mounted at one end to the plate 4, and free at the other end. Without the frame 5, stability may be enhanced by, for example, increasing the diameter of the threaded rods 6 to increase stiffness, or increasing the number of threaded rods 6 used, or making the threaded rods of metal, or bracing the rods together, and the like.

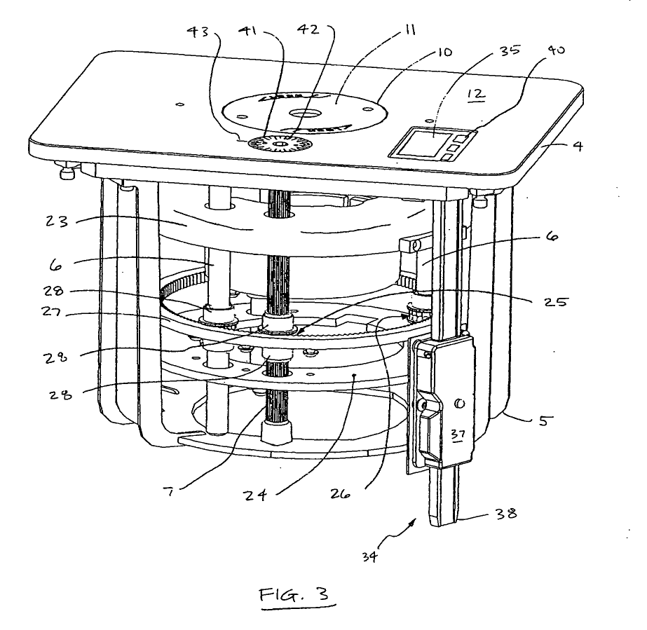

Returning to the embodiment disclosed in FIG. 1, the tool support 1 further includes a carriage 8. In that embodiment, the carriage 8 is mounted on the threaded rods 6 and drive rod 7 so as to permit travel along the length of those rods 6 and 7 upon rotation of the drive rod 7. In particular, as seen in the embodiment of FIG. 3 (in FIG. 3, the carriage parts are shown in an “exploded” view), the carriage 8 comprises an upper part 23 and a lower part 24 that, when mated together, enclose a gear train that is used for converting the rotary motion of the drive rod 7 into translational motion of the carriage 8 along the rods 6 and 7.

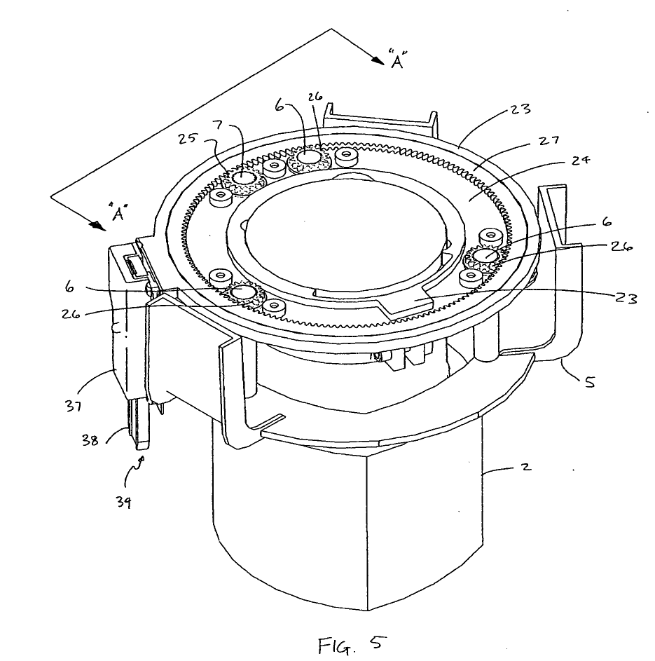

In the embodiment shown in FIGS. 3 and 5 (FIG. 5 is a cut-away section “A”-“A” view through the carriage 8 of the tool support 1), the gear train includes a drive gear 25 mounted to the drive rod 7. In the context of gears, a gear train is a combination of two or more gears used to transmit motion. Of course, the gear train could include or be comprised of belt/pulley combinations, or chain/sprocket combinations, or the like, as the case may be, as well as combinations of those mechanisms. In this embodiment, the drive gear 25 is mounted to the drive rod 7 in a manner that substantially prevents rotation of the drive gear 25 relative to the drive rod 7, yet allows free translation of the drive gear 25 along the drive rod 7. Such mounting may be accomplished if the drive rod 7 and drive gear 25 are, for example, splined. Alternatively, the drive rod 7 may be square, or keyed, for example, and the drive gear 25 correspondingly configured to allow slidable, but not rotational, mounting of the drive gear 25 on the drive rod 7. The gear train also preferably includes an output gear 26 threadably mounted to each threaded rod 6 so as to permit simultaneous rotation and translation of the output gear 26 relative to the threaded rod 6. The gear train further includes a ring gear 27 situated to engage the drive gear 25 and output gears 26 so that rotation of the drive rod 7 effects rotation of the output gears 26. That is, the drive rod 7 turns the drive gear 25, which turns the ring gear 27, which turns the output gears 26. (Of course, those skilled in the art will also recognize that the gear train need not include the drive gear 25, i.e., the drive rod 7 may directly engage the ring gear 27 if provided with splines or teeth.) The drive gear 25 and output gears 26 are preferably each rotatably mounted in bushings 28 fitted into the upper and lower carriage parts 23 and 24 so that the assembled carriage 8 permits substantially only rotational movement of the drive gear 25 and output gears 26 relative to the carriage 8. Thus, when the drive rod 7 rotates, the drive gear 25 turns the ring gear 27, which turns the output gears 26 simultaneously on the threaded rods 6, thus effecting translational movement of the carriage 8 along the threaded rods 6 and drive rod 7. That is, the carriage 8 “rides” on the output gears 26: as the output gears 26 move, so moves the carriage 8. Of course, the router 2, which is held by the carriage 8, also moves with the carriage 8. Accordingly, translational movement of the carriage 8 effects the advancement or withdrawal of the router bit 3 through the hole 10 in the plate 4, as indicated in FIG. 1. Furthermore, in this embodiment, the output gears 26 are synchronized so that as the carriage 8 moves perpendicularly to work surface 12 of the plate 4, the carriage 8 does not tilt or turn, which ensures that the central axis of the router bit 3 remains perpendicular (again, in this embodiment) to the work surface 12 of the plate 4.

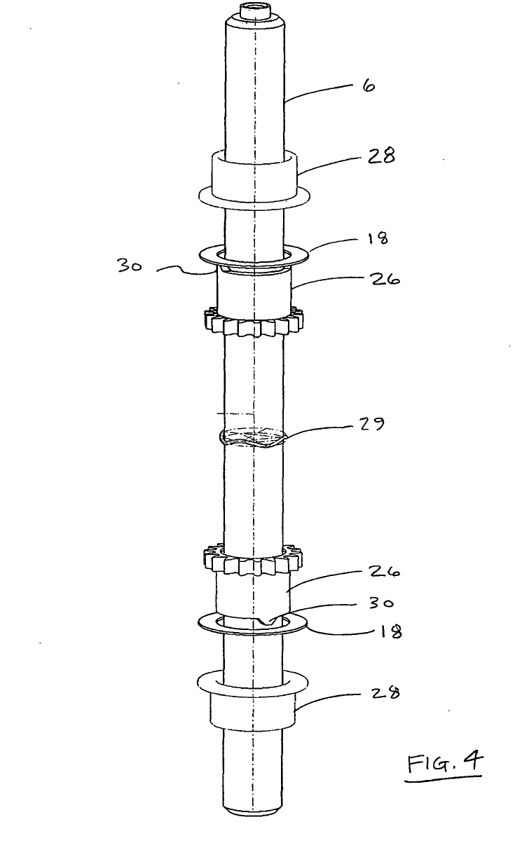

As seen in FIG. 4, each threaded rod 6 may be provided with two output gears 26, or one output gear 26 divided in two parts, arranged so as to reduce backlash, e.g., play in or resulting from the gear train. Focusing on the ensemble for a single threaded rod 6, as seen in more detail in FIG. 4, the two output gears 26 on the threaded rod 6 both engage the ring gear 27 and are urged apart from each other by, for example, a wavy metal washer 29 or other resilient material such as a rubber O-ring (not shown) or coil spring (not shown). Also as seen in FIG. 4, each output gear 26 is provided with a flange 30 for “wiping,” i.e., cleaning, away dust and debris from the threads of the threaded rods 6. Other parts shown in FIG. 4 include the bushings 28 and washers 18.

In the embodiment illustrated in FIGS. 1 and 2, the carriage 8 encloses the gear train to prevent dust and other foreign particles from collecting therein. Those of ordinary skill in the art, however, will understand that such enclosure is not required. At a minimum, the carriage 8 should be connected to the gear train sufficiently to allow translation along the threaded rods 6 as the drive rod 7 (and/or drive motor 46, if motorized) turns. For example, in another embodiment, if the gear train is not enclosed by the carriage, the ring gear 27 may be enlarged to permit manual rotation in lieu of, or in addition to, rotation by the drive rod 7 and drive gear 25. That is, the ring gear 27 in this embodiment may be made thicker and wider, and provided with grip-enhancing cross-hatching or rubber on the outer edge so that it may be turned by hand. Those skilled in the art will further appreciate that the carriage 8 need not enclose the drive gear 25 or be mounted to the drive rod 7, so long as there is some gear/chain/belt or other drive arrangement to convert the rotary motion of the drive rod 7 to translational motion of the carriage 8. That is, the carriage 8 should be connected to at least the output gears 26 in some way so as to move in concert with those gears.

Of course, those skilled in the art will appreciate that the gear train used to effect translational motion of the carriage 8 when the drive rod 7 rotates, may be configured in a variety of ways, and may include various types of gears, belts and chains. For example, the ring gear 27 could be a drive belt, or a chain, such as a ladder chain. The gears could have helical, herringbone, spur, spiral, or the like, tooth patterns.

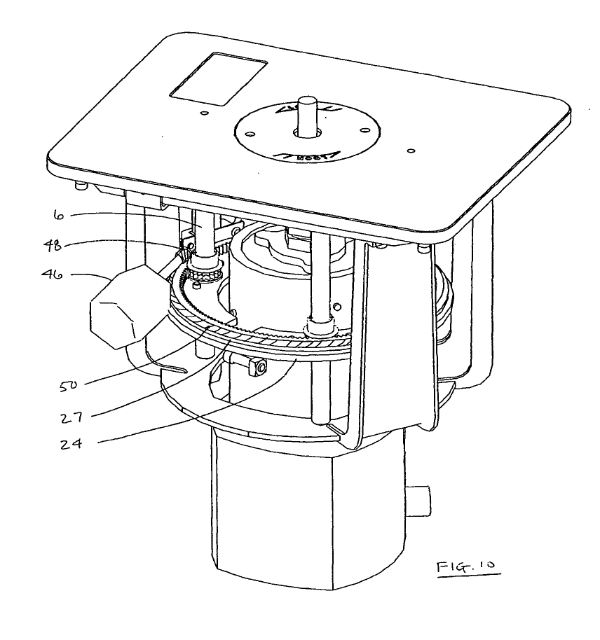

Those skilled in the art will further appreciate that the tool support 1 is not limited to the embodiments described above. For example, a small drive motor or servo motor could be mounted to the carriage 8 to directly engage and turn the ring gear 27 either in lieu of, or in addition to, the drive rod 7 and drive gear 25, such as seen in FIG. 10. In that embodiment, the drive rod 7 and drive gear 25 may be replaced by a drive motor 46. The motor output shaft is fitted with its own drive gear 48 to engage the ring gear 27, which is provided with additional teeth 50 on its top side. In FIG. 10, the upper part of the carriage 8, which the motor 46 is mounted to, is not shown in order to make visible the drive arrangement. The lower part 24 of the carriage 8, however, is shown. Also in that embodiment, as those skilled in the art will appreciate, the motor 46 may drive the ring gear 27 through one or more spur gears, hypoid gears, bevel gears, spiral bevel gears, crossed helical gears, worm gears, and the like, to allow the motor to be mounted at any angle or position on the carriage 8. That is, the ring gear 27 may be provided with additional teeth on, say, the top surface or outer edge, to accommodate various gear types and motor positions. Those of skill in the art will also appreciate that in other embodiments, the motor may be mounted, as discussed above, on the end of a threaded rod 6 extending beyond the frame 5, or to the utility surface 13 of the plate 4, or other locations as may be required by space or safety constraints (for example, some work tables that include a “cabinet” for enclosing the working tool, such as a router, may not provide sufficient space for including a separate drive motor for the tool support 1 in a given orientation). In those embodiments, the drive motor 46 may be drivably connected to the ring gear 27 through drive gear mounted to a flexible drive shaft that is connected to the motor output shaft, or similarly through one or more universal joints.

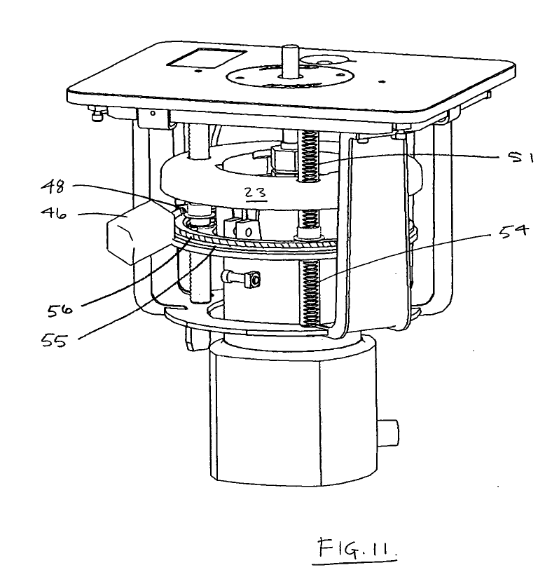

In yet another embodiment, as seen in FIG. 11, posts 51 are used in place of the threaded rods 6. The outside (or, alternatively, on the inside) of each of the posts 51, i.e., the side of the post not facing the hole 10 in the plate 4 (or, alternatively, the side of the post that is facing the hole 10 in the plate 4), is provided with a gear rack 54, the teeth of which are oriented so that the post gear racks 54 collectively form a threaded section onto which a ring gear 55, having matching interior threads (or, alternatively, with matching exterior threads if the gear racks are placed on the inside of the posts), may be threaded. (Of course, the threaded rods 6 may be used if the rod diameter, thread pitch and rod-to-rod thread alignment are correct.) Those skilled in the art will appreciate that the gear rack 54 may be a separate component mounted to the post 51, or may be machined into the post. Thus, in this embodiment, as the ring gear 55 turns on the posts 51, i.e., engages the gear rack 54 of each post 51, the ring gear 55 translates along the post 51 in the same manner as a nut translates along a threaded rod when turned. In this embodiment, the outside or top of the ring gear 55 (or, alternatively, the inside of the ring gear if the gear racks are placed on the inside of the posts) is provided 9 with teeth 56 to engage the drive gear 48 of the drive motor 46. Of course, a drive rod as discussed above could be used instead of a drive motor 46, but the concept is the same. In this embodiment, then, the drive gear 48 of drive motor 46, mounted to the carriage 8 (which is “exploded” for illustration), engages teeth 56 on the top side of the ring gear 55. When the drive motor 46 is actuated, the drive gear 48 turns, as well, thus turning the ring gear 55 and thereby translating the ring gear 55 along the posts 51. Also in this embodiment, the carriage 8 is connected to, e.g., “rides,” on the ring gear 55, and so moves along the posts as the ring gear 55 turns. As before, a number of variations will be apparent to those skilled in the art. For example, the motor output shaft may be oriented to allow a spur gear arrangement to be used, or oriented to allow a bevel, or worm, or hypoid gear arrangement to be used, as those of skill in the art will appreciate. Alternatively, a motor may be used to turn the drive rod 7, as described above. Additionally, if, for example, the gear train is not enclosed by the carriage 8, the ring gear may be made enlarged to permit manual rotation, i.e., the ring gear may be turned by hand, in lieu of, or in addition to, the drive rod 7 and drive gear 25, and drive motor 46.

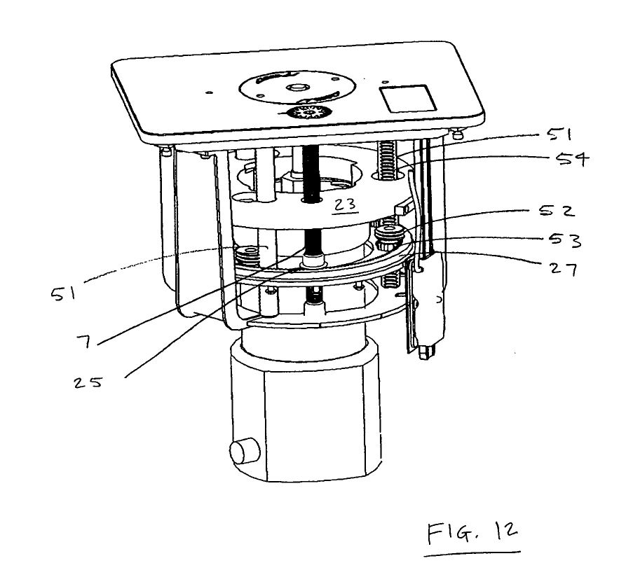

In yet another embodiment, as seen in FIG. 12, the gear train could include small worm gears 52 oriented parallel to posts 51 provided with gear racks 54 (or, alternatively, to threaded rods 6) so that the worm gear 52 teeth engage the teeth of the gear racks 54 (or, alternatively, the threads of the threaded rods 6). In this embodiment, each such worm gear 52 is provided with spur teeth 53 to engage the ring gear 27. Thus, when the drive rod 7 turns, the drive gear 25 turns the ring gear 27, which turns the worm gear, thus translating the carriage 8 along the posts 51. Of course, once again, those skilled in the art will recognize that instead of a spur-tooth arrangement, the ring gear 27 could transfer motion to the worm gear through a bevel gear, hypoid gear, and a like arrangement, or a motor could be used to drive the gear train.

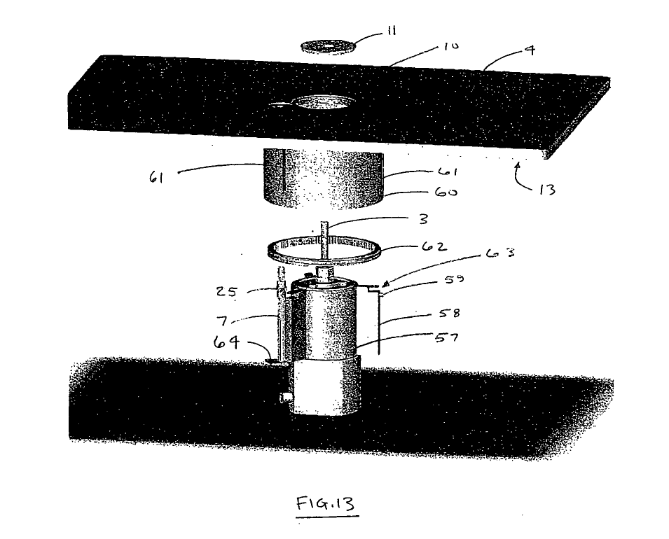

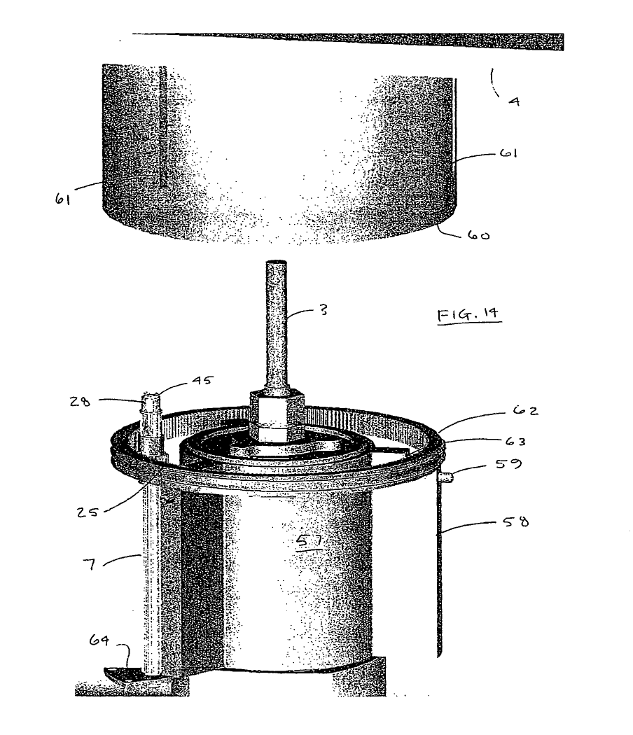

In a further embodiment, as seen in FIGS. 13 and 14 (both of which are “exploded” views to show internal parts), a cylindrical tube 51 is centered around the hole 10 and mounted to the utility surface 13 of the plate 4. The inner wall of the tube 51 is threaded, and further provided with one or more vertical slots 61. The carriage 57 is adapted to fit inside the tube 60, and includes ribs 58 having pins 59 that slide in the vertical slots 61 to substantially prevent rotation relative to the tube 60. In this embodiment, no threaded rods 6 are needed. In the gear train, the outer edge of the ring gear 62 is threaded, and thereby engages the inner wall of the tube 60. The ring gear 62 is further rotatably mounted to the carriage 57, preferably in ring groove 63. In assembled form, then, the gear train, carriage 57, drive mechanism are substantially within the cylinder 60. In this embodiment, the drive rod 7 is rotatably mounted at one end to the plate 4, and at the other end to a support plate 64. As discussed above, though, the drive rod 7 could extend below the support plate 64 for connection to a motor. Thus, when the drive rod 7 is rotated, the drive gear 25 rotates, thereby turning the ring gear 62. As the ring gear 62 rotates, it threads its way along the tube 60, thus translating the carriage 57 along the tube 60 to advance or withdraw the router bit 3 through the hole 10. In this embodiment, the drive rod 7 is manually turned with a hex wrench (not shown).

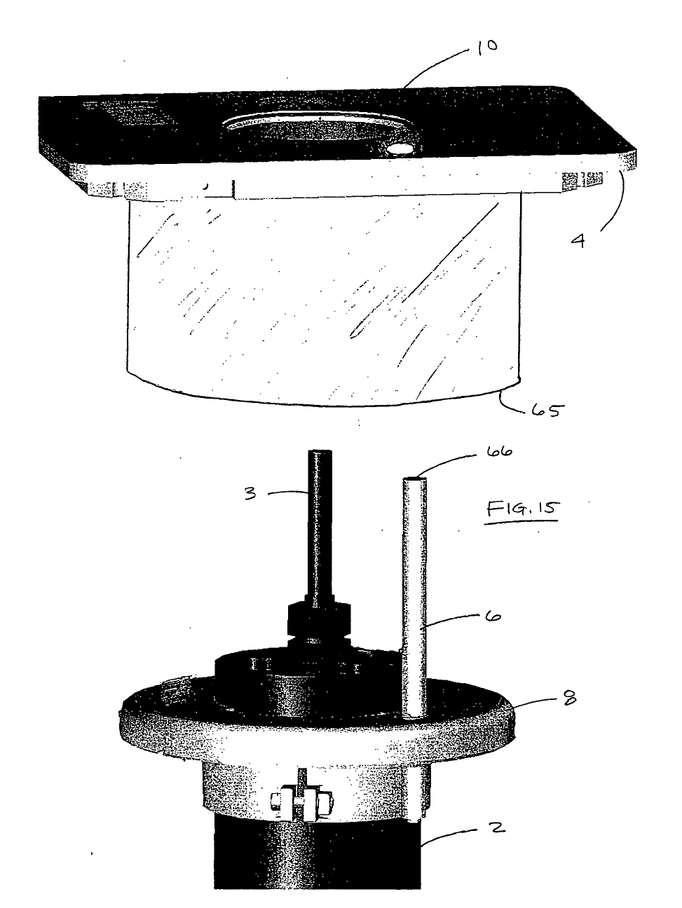

Those skilled in the art will appreciate variations of this embodiment. For example, in the embodiment of FIG. 15, the inner wall of the tube 65 may be smooth, and the carriage 8 may be configured to slide within the tube 65, much as a piston slides in a cylinder. In this embodiment, a threaded rod 6 is used as drive rods, and is simply threaded through the carriage 8, and rotatably mounted to the plate 4, without need for a gear train. Those skilled in the art will readily appreciate that more than one threaded rod 6 may be provided and turned together. Rotation of the threaded rod 6 may be accomplished as described for drive rod 7, e.g., with an internal hex drive 66, motor drive or the like. Thus, when the threaded rod 6 is rotated, the carriage advances or withdraws (depending on the direction of rotation of the threaded rod 6) along the threaded rod 6 inside the cylindrical tube 65. In that embodiment, the carriage 8 may be further provided with a counterweight system (not shown), such as a pulley counterweight, to ease translation of the carriage 8, particularly if the threaded rod 6 is turned by hand. (Of course, such a counterweight system may just as easily be used in other embodiments described herein, as well.) Further in that embodiment, the carriage 8 may be provided with a split nut (not shown) through which the threaded rod 6 is threaded (in the embodiment of FIG. 15, the split nut would be inside the carriage 8). The split nut would be provided to allow the carriage 8 to disengage from the threaded rods 6 for rapid translation of the carriage 8 within the tube 65. Such rapid translation may be assisted by the above-mentioned counterweight system. Thus, rapid movement of the carriage 8 (and thus the tool mounted in therein) within the tube 65 is accomplished by disengaging the split nut from the threaded rod 6 and moving the carriage 8 by hand, and precise movement of the carriage 8 is accomplished by engaging the split nut with the threaded rod 6 and moving the carriage 8 by turning the threaded rods 6. Additionally, those skilled in the art will appreciate that the tube 65 may be polygonal, and the carriage 8 correspondingly configured, so as to further prevent rotation of the carriage 8 relative to the tube 65.

Again, in the embodiment described in detail herein, the carriage 8 is adapted to hold a router 2. As seen in FIG. 6, the carriage 8 is provided with two carriage flanges 31 that may be urged together by, for example, a bolt 32 so as to firmly hold the router 2. Those of ordinary skill in the art will recognize that there are a number of ways other than use of the two flanges 31 by which the router 2 may be affixed to the carriage 8. Whatever the method of mounting, the router 2 is held in the carriage 8 so that the router bit 3 may advance and withdraw through the hole 10 in the plate 4 as the carriage 8 moves back and forth along the threaded rods 6. For example, as also seen in FIG. 6, a router 2 by Porter-Cable® is manufactured with pins 33 used to mount the router 2 bayonet-style to the carriage 8. In that embodiment, the carriage 8 is provided with slots 22 to accommodate bayonet mounting. Those of ordinary skill in the art will further recognize that various other tools may be mounted to the carriage 8 in various ways as required by the shape and function of the particular tool being mounted in the carriage 8. For example, a sander (not shown), having a sanding spindle as the working implement, may readily be mounted in the carriage 8.

As further seen in FIG. 6, the tool support 1 also includes, in this embodiment, an electronic distance gauge 34 to allow an operator to determine, for example, how far beyond the work surface 12 of the plate 4 the router bit 3 protrudes. As seen in more detail in FIG. 7, the plate 4 is provided with a screen 35, visible to the operator, that is used for displaying an output 36 representing, for example, the distance that the router bit 3 protrudes beyond the working surface 12. The electronic distance gauge 34 includes a beam 38 fixed at one end to the utility surface 13 of the plate 4 and parallel to the threaded rods 6. A read head 37 is fixed to the carriage 8 and slidably mounted to the beam 38. As the carriage 8 moves along the threaded rods 6, the read head 37 slides along the beam 38, detects, for example, the distance over which the carriage 8 (and hence the read head 37) has traveled relative to the beam 38, and outputs a distance signal through, for example, a cable 39 for display on the screen 35. The electronic distance gauge 34 may thus function similarly to, for example, digital calipers. Of course, the read head 37 may alternatively be in wireless communication with the screen 35, which generally includes the circuitry supporting screen operation, to avoid the need for a cable 39. The electronic distance gauge 34 may be digital and may be zeroed or calibrated by an operator by using the multi-function switches 40, e.g., membrane switches, situated adjacent the screen 35. The operator may also use those switches 40 to alternate between metric and imperial units of measurement, and to power the gauge 34 on or off. As noted above, the switches 40 may be multi-function and used, for example, to also actuate a motor used to turn the drive rod 7. That is, electronic control and monitoring of the tool support 1 may be accomplished through one screen 35 and set of multi-function switches 40. Those skilled in the art will appreciate that the tool support 1 may be provided with more than one screen 35 and set of switches 40 for ease of use, and that the screen 35 and/or switches 40 may be situated at a place other than in the working surface 12 of the plate 4, such as at the end of or at the side of the work table in which the tool support 1 is mounted.

Other types of distance gauges, such as mechanical distance gauge 9, may also be used. For example, also as seen in FIG. 7, the end 20 of the drive rod 7 may be fitted with a distance gauge disk 41 recessed within the work surface 12 of the plate 4 and having graduation marks 42 situated radially thereabout for indicating how much the drive rod 7 had been turned, which in turn indicates how far the carriage 8 has moved. For example, the threads on the threaded rods 6 may be pitched so that one full turn of the drive rod 7 effects a 1/32″ translation of the carriage 8 along the threaded rods 6. Of course, as those skilled in the art will appreciate, the ratio may be changed by changing the thread pitch of the threaded rods 6 or the relative diameters of the drive gear 25, ring gear 27 and output gear 26. Also, the graduation marks 42 may be etched, painted or otherwise marked into the disk 41, and the work surface 12 may be provided with a mark 43 or other marking to provide a reference point for the operator.

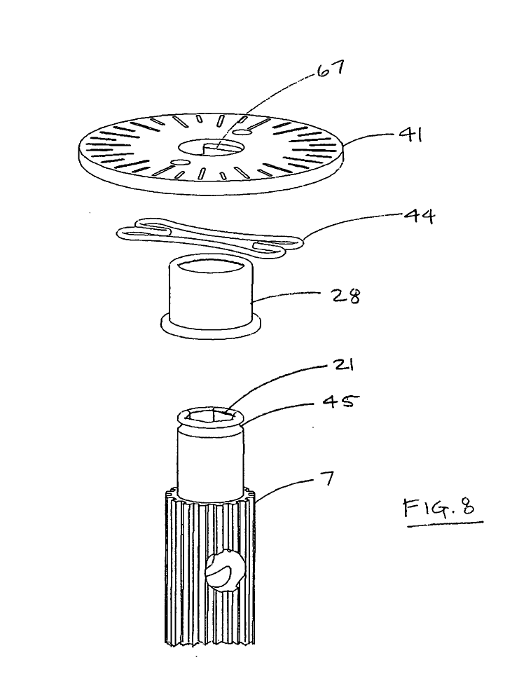

Another embodiment, as seen in FIG. 8, allows calibration of the distance gauge disk 41. In this embodiment, the distance gauge disk 41 is rotatably mounted to the end of the drive rod 7, with a spring drag interface 28 which causes the disk 41 to rotate when the drive rod 7 rotates. The spring 41 is fitted into slots 67 in the disk 41 and into the spring groove 45 of the drive rod 7 over a bushing 28. Use of the spring drag interface 28 allows the disk 41 to be rotated independently of the drive rod 7 for calibration, i.e., resetting the disk 41 graduation marks 42 to a reference mark 43 located on the work surface 12.

In the embodiment of FIG. 6, the tool support 1 is an assembly that may be removably fitted into a larger work surface, such as a table 14, so that the work surface 12 of the plate 4 is flush with the surface of the table 14. In that embodiment, the plate 4 is provided with leveling shims 15, lateral wedges or shims 19 and other means for fitting the plate 4 to the table 14. For example, if the tool support 1 is mounted in a poorly-configured table, e.g., the “pocket” in which the tool support 1 sits is imperfectly machined, the leveling shims 15 are used to ensure that each corner of the plate working surface 12 is at a level flush with the surface of the table 14. The wedges 19 are used to substantially prevent lateral movement of the tool support 1 in the table 14 “pocket.”

In other embodiments, the frame 5 could be permanently or semi-permanently mounted to the reverse side of the work surface of the table, rather than to a plate 4 that fits into that larger work surface. Alternatively, the plate 4 could be a part of the frame 5 such that when the frame 5 and plate 4 are mounted to the work surface of the table 14, the router bit 3 protrudes first through the hole 10 in the plate 4, and then through an opening in the larger work surface of the table 14. Furthermore, as noted above, use of the tool support 1 is not limited to the horizontal orientation described above, but may be mounted and operated at any angle.

Additionally, those skilled in the art will appreciate that all of the embodiments disclosed herein may be hand- or motor-driven, configured in the manners described above and the like to accommodate such drive arrangements. Additionally, it will be apparent to those skilled in the art that features and components of any given embodiment may be readily adapted for use in another embodiment.

To use the tool support to adjust the level of a router, therefore, a router 2 is mounted in the carriage 8 of one embodiment of the tool support 1 in an orientation that permits the router bit 3 to advance and withdraw through the hole 10 in the plate 4 as the carriage 8 moves back and forth along the threaded rods 6. Specifically, the long central axis of the router bit 3 should be parallel to the threaded rods 6 and perpendicular to the work surface 12 of the plate 4. In this embodiment, the tool support 1 then is fitted into the table 14 so that the plate 4 is flush with the work surface of that table 14. A wrench (not shown) is fitted into the end 20 of the drive rod 7 to turn the drive rod 7. The drive gear 25 rotates with the drive rod 7, and turns the ring gear 27, which turns the output gears 26. As the output gears 26 turn, they move along the threaded rods 6, thus moving the carriage 8 and router 2 along, as well. As the carriage 8 moves, the router bit 3 advances through the hole 10 in the plate 4, thus increasing the distance that the router bit 3 extends beyond the working face 12 of the plate 4. Decreasing that distance, then, simply requires rotating the drive rod 7 in the opposite direction. Whether that distance is increased or decreased, the operator may, in this embodiment, readily learn the distance or change therein by using the electronic distance gauge 34.

Those of ordinary skill in the art will understand that other modifications to or configurations of the foregoing embodiment may be accomplished without departing from the scope and purview of the tool support illustrated and described herein as defined in the appended claims Therefore, the invention claimed herein is not to be limited to or by the foregoing description.

1. A tool support comprising:
a plate, said plate defining an aperture;
a plurality of threaded rods, each of said plurality of threaded rods being fixed to said plate;
a drive rod rotatably mounted to said plate;
a gear train operably engaged with said drive rod and said plurality of threaded rods; and
a carriage adapted to hold a tool having a working implement such that the working implement of said tool may protrude through said aperture, said carriage being connected to at least part of said gear train;
wherein said gear train is configured so as to effect translation of said carriage along said plurality of threaded rods upon rotation of said drive rod.

2. The tool support of claim 1, wherein said gear train comprises:
a drive gear slidably mounted to said drive rod, said drive gear constrained from rotation relative to said drive rod;
an output gear threadably mounted to each of said plurality of threaded rods; and
a transfer gear disposed so as to transfer motion from said drive gear to said output gears.

3. The tool support of claim 2, wherein said drive gear and said drive rod are splined.

4. The tool support of claim 2, wherein said transfer gear is a ring gear.

5. The tool support of claim 5, wherein each said output gear further includes a flange for cleaning the threads of said threaded rods.

6. The tool support of claim 2, wherein said gear train further comprises:
a second output gear threadably mounted to each of said plurality of threaded rods; and
a resilient washer disposed so as to urge apart said first output gear and said second output gear on each of said plurality of threaded rods;
wherein said transfer gear transfers said motion to both said first and said second output gears.

7. The tool support of claim 1, further comprising a frame mounted to said plate, wherein said plurality of threaded rods are fixed to said frame and said drive rod is rotatably mounted to said frame.

8. The tool support of claim 1, wherein said gear train comprises:
a drive sprocket slidably mounted to said drive rod, said drive sprocket constrained from rotation relative to said drive rod;
an output sprocket threadably mounted to each of said threaded rods; and
a drive band disposed so as to transfer motion from said drive sprocket to said output sprockets.

9. The tool support of claim 2, wherein said drive sprocket and said drive rod are splined.

10. The tool support of claim 2, wherein said drive band is a chain.

11. The tool support of claim 1, further including a distance gauge.

12. The tool support of claim 13, wherein said distance gauge is an electronic gauge comprising:
a beam fixed at one end to said plate;
a read head fixed to said carriage and slidably mounted to said beam; and
a screen mounted to said plate for displaying an output signal from said read head.

13. The tool support of claim 16, further comprising a switch for controlling said electronic gauge.

14. The tool support of claim 13, wherein said distance gauge comprises a disk mounted to one end of said drive rod, said disk being visible to an operator of said tool support and having graduation marks; and said plate being provided with a corresponding reference mark.

15. The tool support of claim 1, wherein said tool is a router and said working implement is a router bit.

16. The tool support of claims 17, wherein said carriage is provided with two flanges capable of being urged together to hold said router.

17. The tool support of claims 17, wherein said carriage defines a plurality of slots configured to permit bayonet mounting of said router.

18. The tool support of claim 1, wherein said gear train comprises:
a ring gear; and
a drive gear slidably mounted to said drive rod, said drive gear constrained from rotation relative to said drive rod;
a plurality of worm gears, each of said plurality of worm gears engaging one of said plurality of threaded rods, each of said plurality of worm gears further including teeth engagable with said ring gear;
wherein said ring gear engages with the teeth of each of said plurality of worm gears, and with said drive gear.

19. A tool support comprising:
a plate, said plate defining an aperture;
a plurality of threaded rods, each of said plurality of threaded rods being fixed to said plate;
a drive motor;
a gear train operably engaged with said drive motor and said plurality of threaded rods; and
a carriage adapted to hold a tool having a working implement such that the working implement of said tool may protrude through said aperture, said carriage being connected to at least part of said gear train;
wherein said gear train is configured so as to effect translation of said carriage along said plurality of threaded rods upon actuation of said drive motor.

20. The tool support of claim 19, further including a frame, wherein said plurality of threaded rods are fixed to said frame.

21. The tool support of claim 19, wherein said gear train comprises:
a drive gear mounted to said drive motor;
an output gear threadably mounted to each of said plurality of threaded rods; and
a transfer gear disposed so as to transfer motion from said drive gear to said output gears.

22. The tool support of claim 19, wherein said drive gear and said drive rod are splined.

23. The tool support of claim 19, wherein said transfer gear is a ring gear.

24. The tool support of claim 19, wherein each said output gear further includes a flange for cleaning the threads of said threaded rods.

25. The tool support of claim 19, wherein said gear train further comprises:
a second output gear threadably mounted to each of said plurality of threaded rods; and
a resilient washer disposed so as to urge apart said first output gear and said second output gear on each of said plurality of threaded rods;
wherein said transfer gear transfers said motion to both said first and said second output gears.

26. A tool support comprising:
a plate, said plate defining an aperture;
a plurality of posts, each of said plurality of posts being fixed to said plate, each of said plurality of posts including a gear rack;
a drive rod rotatably mounted to said plate;
a gear train operably engaged with said drive rod and said gear rack of each of said plurality of posts; and
a carriage adapted to hold a tool having a working implement such that the working implement of said tool may protrude through said aperture, said carriage being connected to at least part of said gear train;
wherein said gear train is configured so as to effect translation of said carriage along said plurality of posts upon rotation of said drive rod.

27. The tool support of claim 26, wherein said gear train comprises:
a ring gear having internal threads, said internal threads engaged with each said gear rack; and
a drive gear slidably mounted to said drive rod, said drive gear constrained from rotation relative to said drive rod;
wherein the teeth of said drive gear are engaged with said teeth of said ring gear.

28. The tool support of claim 26, wherein said gear train comprises:
a ring gear; and
a drive gear slidably mounted to said drive rod, said drive gear constrained from rotation relative to said drive rod;
a plurality of worm gears, each of said plurality of worm gears engaging one of said gear racks, each of said plurality of worm gears further including teeth engagable with said ring gear;
wherein said ring gear engages with the teeth of each of said plurality of worm gears, and with said drive gear.

29. A tool support comprising:
a plate, said plate defining an aperture;
a tube mounted to said plate;
a threaded drive rod rotatably mounted to said plate;
a carriage adapted to hold a tool having a working implement such that the working implement of said tool may protrude through said aperture, said carriage being slidably disposed substantially within said tube and threadably mounted to said threaded drive rod.

30. A tool support comprising:
a plate, said plate defining an aperture;
a cylinder mounted to said plate, said cylinder having interior threads;
a drive rod rotatably mounted to said plate;
a gear train operably engaged with said drive rod and said interior threads; and
a carriage adapted to hold a tool having a working implement such that the working implement of said tool may protrude through said aperture, said carriage being connected to at least part of said gear train;
wherein said gear train is configured so as to effect translation of said carriage along said cylinder upon rotation of said drive rod.

31. The tool support of claim 30, wherein said gear train comprises:
a drive gear slidably mounted to said drive rod, said drive gear constrained from rotation relative to said drive rod;
a ring gear having exterior threads, said ring gear being threadably mounted in said cylinder, and rotatably mounted to said carriage;
wherein said drive gear engages said teeth of said ring gear.
